(19) United States
(12) Patent Application Publication
(10) Pub. No.: US 2026/0367613 A1
(43) Pub. Date: Nov. 19, 2026

(54) STATUS ANALYSIS DEVICE, ADDITIVE MANUFACTURING SYSTEM, AND STATUS ANALYSIS METHOD

(71) Applicant: Mitsubishi Electric Corporation, Tokyo (JP)

(72) Inventors: Nobuhiro SHINOHARA, Tokyo (JP); Daiji MORITA, Tokyo (JP)

(73) Assignee: Mitsubishi Electric Corporation, Tokyo (JP)

(21) Appl. No.: 19/135,391

(22) PCT Filed: Dec. 22, 2022
(86) PCT No.: PCT/JP2022/047383

§ 371 Date: Jun. 4, 2025

(51) Int. Cl. G05B 19/418; B29C 64/393; B33Y 50/02

(52) U.S. Cl. CPC G05B 19/41875; B29C 64/393; B33Y 50/02; G05B 2219/32368; G05B 2219/49023

(57) ABSTRACT

A status analysis device (100) for monitoring an additive manufacturing system (200) includes multiple measurement devices (101) that each measure a status of a workpiece, a status of an object, or a status of the additive manufacturing system (200) and output a time-series measurement result as log data including logging items; a log data accumulation unit (102) that accumulates multiple pieces of the log data obtained from the multiple measurement devices (101); a sub-trigger extraction unit (103) that extracts sub-triggers from the multiple pieces of the log data, the sub-triggers each being an event included in the log data, the event associating a measurement time of a corresponding one of the multiple pieces of the log data with a reference time, the reference time being a time basis common to the multiple pieces of the log data; a data correction unit (104) that corrects a time deviation among the multiple pieces of the log data on the basis of the sub-triggers to generate synchronized log data having the multiple pieces of the log data synchronized with one another; and an extraction time determination unit (105) that obtains the synchronized log data and determines, on the basis of the reference time, a time section for use in analysis.

### FIELD

The present disclosure relates to a status analysis device, an additive manufacturing system, and a status analysis method.

### BACKGROUND

A technology called additive manufacturing (AM) processing, which is conventionally known as a technology for producing an object, heats and melts building material, and coagulates the melted building material to produce an object. AM processing is also called additive manufacturing, additive fabrication, and the like. AM processing is now facing a demand for recording information about the entire process as the awareness of quality assurance, traceability, and the like increases. In this regard, the mainstream in a processing method such as a conventional cutting process is a logging technology of recording only data before and after an occurrence of processing of insufficient quality, which provides data compression as well. Such method is however ineffective in AM processing. This is because, in AM processing, a problem such as insufficient quality is seldom found in real time during the time of processing, but is often found in a downstream process such as X-ray inspection or a finishing stage. Thus, for the purposes such as quality assurance and investigation of the factor causing insufficient quality, AM processing needs a mechanism to record all sensor data obtainable during AM processing, and ensure that process data of a specific point obtained during building can be traced and checked at a later time.

For technology disclosed in, for example, Patent Literature 1, a three-dimensional (3D) printing system obtains quality information on a three-dimensional object, i.e., information such as control data used in 3D printing processing as well as sensor data obtained by several types of sensors, and then uses the thus obtained information in analysis of causes of insufficient quality.

### CITATION LIST

### Patent Literature

### Patent Literature 1: Japanese Patent Application Laid-open No. 2021-165035

### SUMMARY OF INVENTION

### Problem to be Solved by the Invention

The above-mentioned conventional technology obtains and uses multiple pieces of sensor data and the like. With a larger volume of sensor data used, the possibility of an out-of-synchronization state among the multiple pieces of sensor data becomes greater because of, for example, different signal acquisition paths from the sensors and different communication times. Using the obtained multiple pieces of sensor data as they are presents a problem of possibility of failure in performing highly accurate analysis.

The present disclosure has been made in view of the foregoing, and it is an object of the present disclosure to provide a status analysis device that can ensure synchronism among multiple pieces of log data obtained.

### Means to Solve the Problem

To solve the above problem and achieve the object, the present disclosure a status analysis device to monitor an additive manufacturing system to produce an object on a workpiece by stacking a plurality of layers of beads while moving a fabrication point along a fabrication path, the beads being produced by addition of a melted fabrication material to a fabrication surface of the workpiece. The status analysis device comprises: a plurality of measurement devices each to measure a status of the workpiece, a status of the object, or a status of the additive manufacturing system, and output a time-series measurement result as log data including logging items; a log data accumulation unit to accumulate a plurality of pieces of the log data obtained from the plurality of measurement devices; a sub-trigger extraction unit to extract sub-triggers from the plurality of pieces of the log data, the sub-triggers each being an event included in the log data, the event associating a measurement time of a corresponding one of the plurality of pieces of the log data with a reference time, the reference time being a time basis common to the plurality of pieces of the log data; a data correction unit to correct a time deviation among the plurality of pieces of the log data on a basis of the sub-triggers to generate synchronized log data, the synchronized log data having the plurality of pieces of the log data synchronized with one another; and an extraction time determination unit to obtain the synchronized log data, and determine, on a basis of the reference time, a time section for use in analysis.

### Effects of the Invention

The status analysis device of the present disclosure provides an advantage of ensuring the synchronism among the multiple pieces of log data obtained.

### BRIEF DESCRIPTION OF DRAWINGS

FIG. 1 is a diagram illustrating an exemplary configuration of a status analysis device according to a first embodiment.

FIG. 2 is a flowchart illustrating an operation of the status analysis device according to the first embodiment.

FIG. 3 is a diagram illustrating an example of configuration of processing circuitry that implements the status analysis device according to the first embodiment when the processing circuitry is implemented by a combination of a processor and a memory.

FIG. 4 is a diagram illustrating an example of configuration of processing circuitry that implements the status analysis device according to the first embodiment when the processing circuitry is implemented in a dedicated hardware element.

FIG. 5 is a diagram illustrating an exemplary configuration of a status analysis device according to a second embodiment.

FIG. 6 is a diagram for describing an operation of extraction of shape-forming condition correction points of an additive manufacturing system, performed by a quality analysis unit included in the status analysis device according to the second embodiment.

FIG. 7 is a diagram illustrating an exemplary configuration of a status analysis device according to a third embodiment.

FIG. 8 is a diagram illustrating an exemplary configuration of a status analysis device according to a fourth embodiment.

FIG. 9 is a diagram illustrating an exemplary configuration of a status analysis device according to a fifth embodiment.

FIG. 10 is a diagram illustrating an exemplary configuration of a status analysis device according to a sixth embodiment.

FIG. 11 is a diagram illustrating an exemplary configuration of a status analysis device according to a seventh embodiment.

FIG. 12 is a diagram illustrating an exemplary configuration of a status analysis device according to an eighth embodiment.

FIG. 13 is a diagram illustrating an exemplary configuration of a status analysis device according to a ninth embodiment.

### DESCRIPTION OF EMBODIMENTS

A status analysis device, an additive manufacturing system, and a status analysis method according to embodiments of the present disclosure will be described in detail below with reference to the drawings.

### First Embodiment

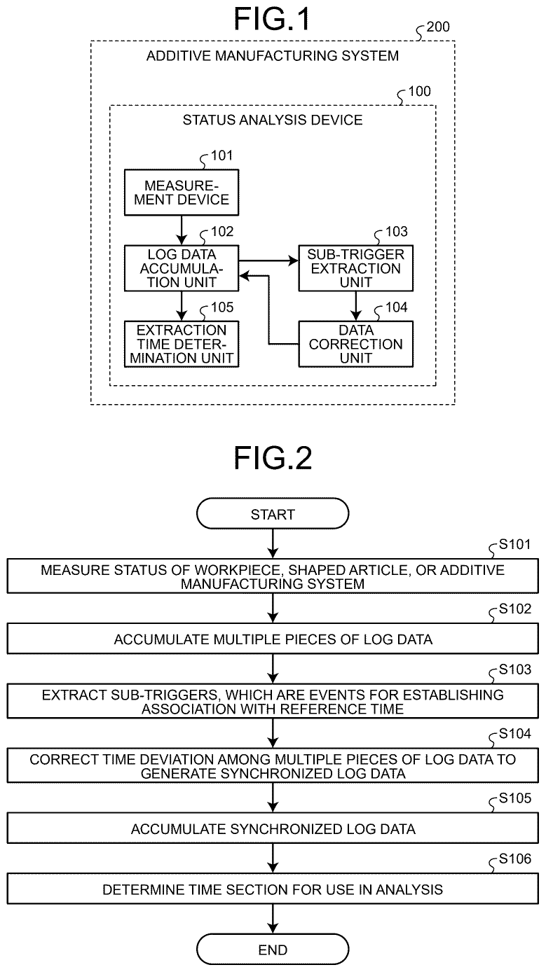

FIG. 1 is a diagram illustrating an exemplary configuration of a status analysis device 100 according to a first embodiment. The status analysis device 100 includes a measurement device 101, a log data accumulation unit 102, a sub-trigger extraction unit 103, a data correction unit 104, and an extraction time determination unit 105. Although omitted in FIG. 1 for simplicity, the status analysis device 100 actually includes multiple measurement devices 101. In addition, although the status analysis device 100 is illustrated in the example of FIG. 1 as being installed in an additive manufacturing system 200, the status analysis device 100 may be installed outside the additive manufacturing system 200; however, at least one of the multiple measurement devices 101 of the status analysis device 100 is installed in the additive manufacturing system 200. The following description is made, by way of example, as to the status analysis device 100 installed in the additive manufacturing system 200, that is, the additive manufacturing system 200 including the status analysis device 100, as illustrated in FIG. 1.

The additive manufacturing system 200 is a system that produces an object on a workpiece by stacking multiple layers of beads while moving a fabrication point along a fabrication path, the beads being produced by addition of melted fabrication material to a fabrication surface of the workpiece. The status analysis device 100 is a device that monitors the additive manufacturing system 200 and analyzes a status of the workpiece, a status of the object, or a status of the additive manufacturing system 200.

The multiple measurement devices 101 each measure a status of the workpiece, a status of the object, or a status of the additive manufacturing system 200, and each output a time-series measurement result to the log data accumulation unit 102 as log data including logging items. The logging items represent names of data such as the measurement devices 101 and measurement items. When there are the same type of multiple measurement devices 101, the logging items may additionally include identification information such as an identification number, for individually identifying the same type of the measurement devices 101. The log data includes the logging items and specific numerical data measured by the measurement devices 101. The log data is, for example, data in a comma separated value (CSV) file having a format including data names in the first row and specific numerical data in the second and subsequent rows. The multiple measurement devices 101, which measure the status of the workpiece, the status of the object, or the status of the additive manufacturing system 200 as described above, include, for example, various types of sensors such as a camera, a radiation thermometer, and/or a thermocouple as well as a numerical control device (referred to hereinafter as NC device) for operating the additive manufacturing system 200, a logger, an analog-to-digital converter, etc. The camera, for example, captures images of the state of a molten pool on the fabrication surface of the additive manufacturing system 200, and outputs the captured images in temporal order.

The log data accumulation unit 102 accumulates multiple pieces of the log data obtained from the multiple measurement devices 101. The log data accumulation unit 102 also accumulates synchronized log data having the multiple pieces of the log data generated in synchronization by the data correction unit 104, as described later. The log data accumulation unit 102 accumulates both the multiple pieces of the log data obtained from the multiple measurement devices 101 and the synchronized log data generated by the data correction unit 104, but the operation is not limited thereto. Depending on the capacity of data that can be accumulated, the log data accumulation unit 102 may either delete the synchronized log data and the multiple pieces of the log data after a lapse of a predetermined time period since the beginning of accumulation, or delete only the multiple pieces of the log data after a lapse of a predetermined time period since the beginning of accumulation. In addition, the log data accumulation unit 102 may go through the process of verifying that the log data or the synchronized log data that should be deleted in the log data accumulation unit 102 has been transferred to another storage device such as an external server, after which the log data accumulation unit 102 may delete that data. As the measurement devices 101 often include a buffer for data transferring, data can be saved in the log data accumulation unit 102 even with a time lag to the extent that log data is not overwritten before being transferred from the buffer to the log data accumulation unit 102. This mean that it is not necessary to store the data in the log data accumulation unit 102 in real time.

The sub-trigger extraction unit 103 obtains the multiple pieces of the log data from the log data accumulation unit 102. The sub-trigger extraction unit 103 extracts sub-triggers from the multiple pieces of the log data. The sub-triggers are each an event included in the log data, the event associating a measurement time of a corresponding one of the multiple pieces of the log data with a reference time, the reference time being a time basis common to the multiple pieces of the log data. The sub-trigger, which is a distinctive measurement event, indicates a change in the operational status in the additive manufacturing system 200. The sub-trigger is, for example, a change in a current representing the output state of the laser (not illustrated), a change in the temperature around the molten pool of the melted fabrication material, etc. when the output of a laser has changed. The sub-trigger also includes, for example, changes in current flowing through multiple motors driven for changing the position of the workpiece when the fabrication path is changed. Events detected as sub-triggers also include not only emission of light, a temperature, a sound, etc., but also a contact status detectable by a force sensor, a pressure sensor, etc., passage of a particular position detectable by a photoelectric sensor, etc., a gas flow rate detectable by a flow sensor, etc. Although the sub-triggers extracted by the sub-trigger extraction unit 103 also include an event when a fault occurs in the additive manufacturing system 200, the assumption is that most of the sub-triggers are events detected during normal operation of the additive manufacturing system 200.

The reference time is a time used for time synchronization when the times used in the multiple pieces of the log data are out of synchronization. The reference time can be the time used in one of the measurement devices 101 that has output a certain specific piece of the log data. For example, the reference time is the time used in a camera, or the time used in an NC device that is one type of the measurement devices 101. Alternatively, when time is counted in the log data accumulation unit 102 or in the sub-trigger extraction unit 103, the time used in the log data accumulation unit 102 or in the sub-trigger extraction unit 103 may be used as the reference time.

The data correction unit 104 corrects a time deviation among the multiple pieces of the log data on the basis of the sub-triggers extracted by the sub-trigger extraction unit 103, and thus generates the synchronized log data having the multiple pieces of the log data synchronized with one another. The data correction unit 104 accumulates the generated synchronized log data in the log data accumulation unit 102 as described above. Specifically, when times of sub-triggers of the same event extracted by the sub-trigger extraction unit 103 deviate from each other in multiple pieces of the log data corresponding to the sub-triggers extracted, the data correction unit 104 corrects the deviation among the times of the extracted sub-triggers, that is, generates synchronized log data so as to eliminate the deviation among the times of the extracted sub-triggers.

When sub-triggers corresponding to an event common in all of the pieces of log data cannot be extracted, the data correction unit 104 corrects the time deviation among the log data, using sub-triggers corresponding to an event common in some pieces of the log data, thereby generating synchronized log data having all of pieces of log data synchronized with one another. For example, assume that all of the pieces of log data are log data pieces A, B, C, and D, in which sub-triggers corresponding to a first event common to the log data pieces A and B are extracted from the log data pieces A and B, sub-triggers corresponding to a second event common to the log data pieces A and C are extracted from the log data pieces A and C, sub-triggers corresponding to a third event common to the log data pieces B and D are extracted from the log data pieces B and D, and the time used in the log data piece A is the reference time. In such case, the data correction unit 104 can correct the time deviation among all the log data pieces A, B, C, and D by adjusting the time of the log data piece B to the time of the log data piece A to thus correct the time deviation therebetween, adjusting the time of the log data piece C to the time of the log data piece A to thus correct the time deviation therebetween, and adjusting the time of the log data piece D to the time of the log data piece B having the time deviation already corrected, to thus correct the time deviation therebetween.

The extraction time determination unit 105 obtains the synchronized log data from the log data accumulation unit 102, and determines, on the basis of the reference time, a time section for use in analysis. The time section for use in analysis is the time from start to end of operation of additive manufacturing performed by the additive manufacturing system 200. Depending on, for example, the type of the corresponding one of the measurement devices 101, the log data output from each of the multiple measurement devices 101 may include log data such as log data in a time range before the start of operation of additive manufacturing performed by the additive manufacturing system 200 and/or log data in a time range after the end of operation of additive manufacturing performed by the additive manufacturing system 200, in addition to the log data in a time section that is the time from start to end of operation of additive manufacturing performed by the additive manufacturing system 200. Examples of such a time range include a time range over which a user of the additive manufacturing system 200 does work of changing a system parameter. The extraction time determination unit 105 thus obtains, from the log data accumulation unit 102, the synchronized log data generated by the data correction unit 104, and determines, on the basis of the reference time of the synchronized log data, the time section. When, for example, the multiple measurement devices 101 include a camera, the extraction time determination unit 105 can determine the time section on the basis of an image included in the log data which the camera captured. The extraction time determination unit 105 may determine the time section, using log data from some of the measurement devices 101 among the multiple measurement devices 101, e.g., log data of a current or voltage detected at and after the start of operation of additive manufacturing performed by the additive manufacturing system 200, log data of a current or voltage that becomes no longer detected after the end of operation of additive manufacturing performed by the additive manufacturing system 200, and/or the like. The extraction time determination unit 105 may determine the time section, using timings of start and end of a G code executed by an NC device that is operating also as one of the measurement devices 101.

The status analysis device 100 can obtain the synchronized log data synchronized with the reference time, using the time section determined by the extraction time determination unit 105. That is, the status analysis device 100 can ensure synchronism among the obtained multiple pieces of the log data. In addition, the status analysis device 100 can also obtain an accurate production time per one object in the additive manufacturing system 200, using the time section determined by the extraction time determination unit 105. Even when the additive manufacturing system 200 operates for a long production time, moreover, the status analysis device 100 can obtain log data during the production time, and can further obtain synchronized log data based on the log data during the production time.

An operation of the status analysis device 100 will next be described using a flowchart. FIG. 2 is a flowchart illustrating an operation of the status analysis device 100 according to the first embodiment. In the status analysis device 100, the multiple measurement devices 101 each measure the status of the workpiece, the status of the object, or the status of the additive manufacturing system 200 (step S101), and output log data to the log data accumulation unit 102. The log data accumulation unit 102 accumulates multiple pieces of the log data obtained from the multiple measurement devices 101 (step S102). The sub-trigger extraction unit 103 obtains, from the log data accumulation unit 102, the multiple pieces of the log data accumulated therein, and extracts sub-triggers from the multiple pieces of the log data (step S103). The sub-triggers are each an event for association with a reference time. The data correction unit 104 corrects a time deviation among the multiple pieces of the log data on the basis of the sub-triggers extracted by the sub-trigger extraction unit 103, and generates synchronized log data having the multiple pieces of the log data synchronized with one another (step S104), and outputs the synchronized log data to the log data accumulation unit 102. The log data accumulation unit 102 accumulates the synchronized log data obtained from the data correction unit 104 (step S105). The extraction time determination unit 105 obtains, from the log data accumulation unit 102, the synchronized log data accumulated in the log data accumulation unit 102 and determines, on the basis of the reference time, a time section for use in analysis (step S106).

A hardware configuration of the status analysis device 100 according to the first embodiment will next be described. In the status analysis device 100, the measurement devices 101 are, as described above, various types of sensors such as a camera, a radiation thermometer, and/or a thermocouple. The log data accumulation unit 102 is a memory. The sub-trigger extraction unit 103, the data correction unit 104, and the extraction time determination unit 105 are implemented by processing circuitry. The processing circuitry may be a combination of a memory for storing a program and a processor that executes the program stored in the memory, or may be a dedicated hardware element. The processing circuitry is also called control circuit.

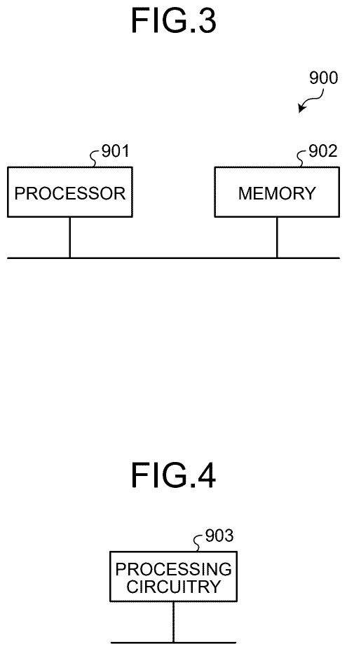

FIG. 3 is a diagram illustrating an example of configuration of a processing circuitry 900 that implements the status analysis device 100 according to the first embodiment when the processing circuitry is implemented by a combination of a processor 901 and a memory 902. The processing circuitry 900 illustrated in FIG. 3 is a control circuit, and includes the processor 901 and the memory 902. When the processing circuitry 900 includes the processor 901 and the memory 902, each functionality of the processing circuitry 900 is implemented in software, firmware, or a combination of software and firmware. The software or firmware is described in the form of a program, and is stored in the memory 902. The processing circuitry 900 provides each functionality in such a manner that the processor 901 reads and executes a program stored in the memory 902. That is, the processing circuitry 900 includes the memory 902 for storing a program that causes processing of the status analysis device 100 to be performed. It can also be said that this program is a program to be executed by the status analysis device 100 implemented by the processing circuitry 900. This program may be provided using a storage medium storing the program or using another means such as a communication medium.

In this respect, the processor 901 is, for example, a central processing unit (CPU), a processing unit, a computing unit, a microprocessor, a microcomputer, a digital signal processor (DSP), or the like. In addition, the memory 902 is, for example, a non-volatile or volatile semiconductor memory such as a random access memory (RAM), a read-only memory (ROM), a flash memory, an erasable programmable ROM (EPROM), or an electrically erasable programmable ROM (EEPROM) (registered trademark) ; a magnetic disk, a flexible disk, an optical disk, a compact disc, a MiniDisc, a digital versatile disc (DVD), or the like.

FIG. 4 is a diagram illustrating an example of configuration of a processing circuitry 903 that implements the status analysis device 100 according to the first embodiment when the processing circuitry is implemented in a dedicated hardware element. The processing circuitry 903 illustrated in FIG. 4 is, for example, a single circuit, a set of multiple circuits, a programmed processor, a parallel programmed processor, an application specific integrated circuit (ASIC), a field programmable gate array (FPGA) , or a combination thereof. The processing circuitry 903 may be implemented partially in a dedicated hardware element and partially in software or firmware. Thus, the processing circuitry 903 can provide each functionality described above in a dedicated hardware element, software, firmware, or a combination thereof.

In the status analysis device 100 according to the present embodiment, as described above, the multiple measurement devices 101 measure the status of the workpiece, the status of the object, or the status of the additive manufacturing system 200, and output log data. The sub-trigger extraction unit 103 extracts sub-triggers from multiple pieces of the log data, the sub-triggers each being an event for association with a reference time. The data correction unit 104 corrects a time deviation among the multiple pieces of the log data on the basis of the sub-triggers, and generates synchronized log data having the multiple pieces of the log data synchronized with one another. The extraction time determination unit 105 determines a time section for use in analysis, on the basis of the reference time. This enables the status analysis device 100 to obtain the synchronized log data synchronized with the reference time, and to ensure synchronism among the multiple pieces of the obtained log data.

### Second Embodiment

A second embodiment will be described with respect to an operation of a status analysis device when an additive manufacturing system performs additive manufacturing using a laser-based wire-fed directed energy deposition (DED) technique.

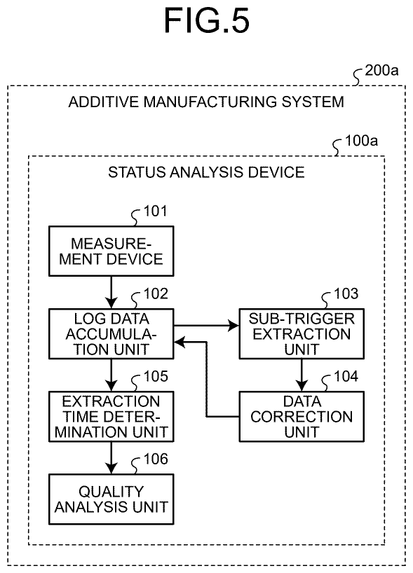

FIG. 5 is a diagram illustrating an exemplary configuration of a status analysis device 100a according to the second embodiment. The status analysis device 100a further includes a quality analysis unit 106 in addition to the components of the status analysis device 100 illustrated in FIG. 1. Although the status analysis device 100a is illustrated in the example of FIG. 5 as being installed in an additive manufacturing system 200a, the status analysis device 100a may be installed outside the additive manufacturing system 200a; however, at least one of the multiple measurement devices 101 of the status analysis device 100a is installed in the additive manufacturing system 200a. The following description is made, by way of example, as to the status analysis device 100a installed in the additive manufacturing system 200a, that is, the additive manufacturing system 200a including the status analysis device 100a, as illustrated in FIG. 5.

The additive manufacturing system 200a is a system that produces an object on a workpiece by stacking multiple layers of beads while moving a fabrication point along a fabrication path, the beads being produced by addition of melted fabrication material to a fabrication surface of the workpiece. The status analysis device 100a is a device that monitors the additive manufacturing system 200a and analyzes the status of the workpiece, the status of the shaped article, or the status of the additive manufacturing system 200a.

In the second embodiment, the multiple measurement devices 101 include, at least, a camera capable of capturing an image of an area including a molten pool in which a wire is melted in the additive manufacturing system 200a, or a sensor capable of measuring a load exerted on the wire used in the additive manufacturing system 200a and a sensor capable of identifying a change in the temperature of a tip portion of the wire. The sensor capable of identifying a change in the temperature of a tip portion of the wire may be a sensor capable of identifying the temperature of the molten pool. That is, the multiple pieces of the log data output from the multiple measurement devices 101 and accumulated in the log data accumulation unit 102 include at least: images captured by a camera, the camera being one type of the measurement devices 101; or a wire load and data capable of identifying at least one of a change in the temperature of a tip portion of the wire or a change in the temperature near the molten pool of melted wire. The wire is used as the fabrication material. The wire load, which is force exerted by the object on the wire, is measured by a sensor that is one type of the measurement devices 101. The sensor capable of identifying a change in the temperature of a tip portion of the wire is, for example, a thermometer, an illuminance meter, etc. An illuminance meter is capable of identifying a change in the temperature of a tip portion of a wire because a change in the temperature of a tip portion of a wire causes a change in the intensity of light in the tip portion of the wire.

In the status analysis device 100a, the log data accumulation unit 102, the sub-trigger extraction unit 103, the data correction unit 104, and the extraction time determination unit 105 operate similarly to those components used in the first embodiment.

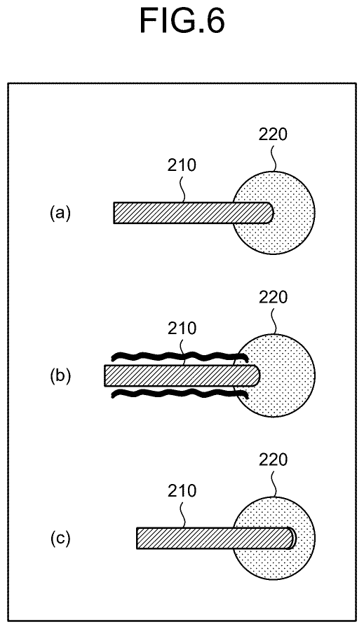

The quality analysis unit 106 extracts, in temporal order, correction points of a building condition for the additive manufacturing system 200a in the time section determined by the extraction time determination unit 105, on the basis of the synchronized log data. An operation of the quality analysis unit 106 will next be described specifically. FIG. 6 is a diagram for describing how the quality analysis unit 106 of the status analysis device 100a according to the second embodiment performs an operation of extraction of correction points of the building condition for the additive manufacturing system 200a. FIG. 6 illustrates situations in which the additive manufacturing system 200a melts a wire 210, which is the fabrication material, by a laser not illustrated, and adds the melted fabrication material onto a fabrication surface of a workpiece. FIG. 6 illustrates situations viewed from above a molten pool 220.

FIG. 6(a) illustrates a situation in which the wire 210 is melted reaching the center of the molten pool 220, the molten pool 220 has an appropriate height, and no vibration is induced on the wire 210. In this case, the quality analysis unit 106 determines that the additive manufacturing system 200a is in normal condition, and extracts no building-condition correction points.

FIG. 6(b) illustrates a situation in which the wire 210 is melted in a left-side portion of the molten pool 220, i.e., in a portion on the side that supplies the wire 210, the molten pool 220 has a large height, and vibration is induced on the wire 210. In this case, the quality analysis unit 106 determines that, in the additive manufacturing system 200a, the wire 210 vibrates with a small amplitude as the wire 210 forced into the molten pool 220 is melted in the molten pool 220 in such a manner that the wire parts the molten pool 220; thus, the quality analysis unit 106 extracts such status as a building-condition correction point. The quality analysis unit 106 is capable of visualizing and recognizing such a situation as illustrated in FIG. 6(b), using video data obtained by a camera included in the multiple measurement devices 101 or data on the wire load measured by a sensor included in the multiple measurement devices 101.

FIG. 6(c) illustrates a situation in which the wire 210 is melted entering a right-side portion of the molten pool 220, i.e., in a portion on the side farther from the side that supplies the wire 210, the molten pool 220 has a small height, and no vibration is induced on the wire 210. In this case, because light in a tip portion of the wire 210 has a higher intensity than those of FIGS. 6(a) and 6(b), etc. in the additive manufacturing system 200a, the quality analysis unit 106 extracts such status as a building-condition correction point. The quality analysis unit 106 is capable of visualizing and recognizing such a situation as illustrated in FIG. 6(c), using video data obtained by a camera included in the multiple measurement devices 101 or data on the temperature in a tip portion of the wire 210 measured by a sensor included in the multiple measurement devices 101.

In addition to the foregoing events, rectification failure due to incorrect setting of the wire 210, anomalous curl of the wire 210 caused by non-uniform winding of the wire 210 wound around a bobbin, and the like are detectable by a camera and a sensor capable of measuring the load exerted on the wire 210. In the case of anomalous curl, vertical and/or horizontal movement of a tip portion of the wire 210 off the center of the molten pool 220 can be captured by a camera, and/or discrete load values may be obtainable from a sensor. In addition, further including a sensor for measuring the height of the object enables distinction to be made between the event of FIG. 6(a) and an event that incorrect setting of the wire 210 has caused the wire 210 to reach the center of the molten pool 220 although the object has a height out of a reasonable range. Similarly, the above configuration also enables distinction to be made between the event of FIG. 6(b) and an event that incorrect setting of the wire 210 has caused the wire 210 to be positioned in a left-side portion in the molten pool 220 although the object has a height within a reasonable range. Similarly, the above configuration also enables distinction to be made between the event of FIG. 6(c) and an event that incorrect setting of the wire 210 has caused the wire 210 to enter a right-side portion of the molten pool 220 although the object has a height within a reasonable range. Moreover, when the incorrect setting of the wire 210 described above is caused in connection with strictness of setting accuracy of wire 210-feeding angle, a feed angle sensor for the wire 210 or a camera for monitoring the wire 210-feeding angle may be further included. This will enable the wire 210-feeding angle to be obtained by the feed angle sensor, or an image showing the wire 210-feeding angle to be captured by the camera. These are effective methods when the wire 210 is used that is formed of a material whose status is highly variable from bead layer to bead layer.

The example of FIG. 6 is an example. The quality analysis unit 106 is capable of extracting a shape-forming condition correction point when the status deviates from the status when the additive manufacturing system 200a is in normal condition. In addition, description has been provided with respect to an operation of the status analysis device 100a in the additive manufacturing system 200a that uses a laser-based wire-fed DED technique, but the status analysis device 100a is obviously applicable also to additive manufacturing systems that use techniques such as a powder bed fusion (PBF) technique and a binder jetting (BJT) technique only with a change of normality determination method.

A hardware configuration of the status analysis device 100a according to the second embodiment will next be described. In the status analysis device 100a, components from the measurement device 101 to the extraction time determination unit 105 have the hardware configuration described in the first embodiment. The quality analysis unit 106 is implemented by processing circuitry. The processing circuitry may be a combination of a memory for storing a program and a processor that executes the program stored in the memory, or may be a dedicated hardware element.

In the status analysis device 100a according to the present embodiment, as described above, the quality analysis unit 106 extracts, in temporal order, correction points of the building condition of the additive manufacturing system 200a on the basis of the synchronized log data. In addition to providing the advantage described in the first embodiment, this enables the status analysis device 100a to easily extract a point that should be changed in the building condition in the case of, for example, introducing a new material or building an object of a new shape in the additive manufacturing system 200a.

### Third Embodiment

A third embodiment will be described with respect to a case where a status analysis device predicts deterioration of an additive manufacturing system.

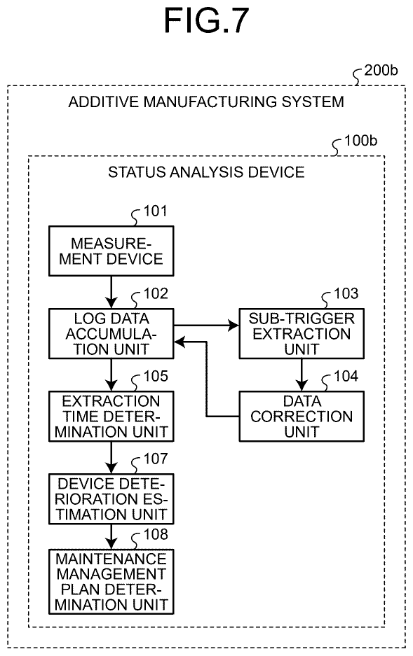

FIG. 7 is a diagram illustrating an exemplary configuration of a status analysis device 100b according to the third embodiment. The status analysis device 100b further includes a device deterioration estimation unit 107 and a maintenance management plan determination unit 108 in addition to the components of the status analysis device 100 illustrated in FIG. 1. Although the status analysis device 100b is illustrated in the example of FIG. 7 as being installed in an additive manufacturing system 200b, the status analysis device 100b may be installed outside the additive manufacturing system 200b; however, at least one of the multiple measurement devices 101 of the status analysis device 100b is installed in the additive manufacturing system 200b. The following description is made, by way of example, as to the status analysis device 100b installed in the additive manufacturing system 200b, that is, the additive manufacturing system 200b including the status analysis device 100b, as illustrated in FIG. 7.

The additive manufacturing system 200b is a system that produces an object on a workpiece by stacking multiple layers of beads while moving a fabrication point along a fabrication path, where the beads being produced by addition of a melted fabrication material to a fabrication surface of the workpiece. The status analysis device 100b is a device that monitors the additive manufacturing system 200b and analyzes the status of the workpiece, the status of the object, or the status of the additive manufacturing system 200b.

In the status analysis device 100b, the measurement devices 101, the log data accumulation unit 102, the sub-trigger extraction unit 103, the data correction unit 104, and the extraction time determination unit 105 operate similarly to those components used in the first embodiment.

The device deterioration estimation unit 107 predicts a deterioration time in the time section determined by the extraction time determination unit 105, on the basis of the synchronized log data. The deterioration time is a time of occurrence of deterioration at which accuracy in additive manufacturing performed by the additive manufacturing system 200b exceeds a predetermined range of tolerance. For example, in a case where the additive manufacturing system 200b includes the status analysis device 100b, and the status analysis device 100b uses a previously installed measurement device 101, the manufacturer of the status analysis device 100b or the like stores, in the device deterioration estimation unit 107, information on a range of a numerical value acceptable as a normal condition, i.e., information on tolerance, for an item measurable by that previously installed measurement device 101. In addition, in a case where the measurement devices 101 installed in the status analysis device 100b is retrofitted by, for example, a user of the status analysis device 100b, the user of the status analysis device 100b or the like stores, in the device deterioration estimation unit 107, information on a range of a numerical value acceptable as the normal condition, i.e., information on tolerance, for an item measurable by that measurement device 101. Note that in either of the cases where that measurement device 101 has been previously installed in the status analysis device 100b and where that measurement device 101 has been retrofitted, the device deterioration estimation unit 107 may obtain the tolerance, i.e., the range of a numerical value acceptable as the normal condition, through learning, for an item measurable by that measurement device 101. Note that the manufacturer of the status analysis device 100b may be the manufacturer of the additive manufacturing system 200b, and the user of the status analysis device 100b may be a user of the additive manufacturing system 200b. This also applies to the devices indicated by similar reference symbols having different suffixes in the following description.

In addition, the log data accumulation unit 102 may obtain log data about devices as standard acquisition items to thereby allow the device deterioration estimation unit 107 to detect deterioration not only from a viewpoint of accuracy in additive manufacturing but also from a viewpoint of operational status of a device itself. For example, obtaining a laser output command value and a laser output feedback (FB) value makes it possible to estimate an anomaly such as an unclean surface, damage, etc. of a fiber and a condenser lens when the difference between the two values significantly deviates from a tolerance range. Similarly, obtaining a wire feed speed command value and a wire feed FB speed value makes it possible to estimate an anomaly in a wire feed system when the difference between the two values significantly deviates from a tolerance range.

The maintenance management plan determination unit 108 determines, on the basis of the deterioration time, a maintenance management plan including a time to perform maintenance of the additive manufacturing system 200b and a time to replace a component of the additive manufacturing system 200b. For example, when the device deterioration estimation unit 107 predicts a deterioration time for some component of the additive manufacturing system 200b, the maintenance management plan determination unit 108 determines a maintenance management plan to perform maintenance, replacement, etc. of that component before the deterioration time is reached. In addition, the maintenance management plan determination unit 108 may determine a maintenance management plan to promptly replace a lens used in a laser of the additive manufacturing system 200b when the device deterioration estimation unit 107 determines that such lens is not transparent. In a case where the additive manufacturing system 200b includes the status analysis device 100b, and the status analysis device 100b uses a previously installed measurement devices 101, the manufacturer of the status analysis device 100b or the like may store a maintenance management plan as a baseline in the maintenance management plan determination unit 108, in view of the lives of components used in the additive manufacturing system 200b. In addition, in a case where the measurement devices 101 installed in the status analysis device 100b is retrofitted by, for example, a user of the status analysis device 100b, the user of the status analysis device 100b or the like may store a maintenance management plan as a baseline in the maintenance management plan determination unit 108, in view of the lives of components used in the additive manufacturing system 200b.

A hardware configuration of the status analysis device 100b according to the third embodiment will next be described. In the status analysis device 100b, components from the measurement device 101 to the extraction time determination unit 105 have the hardware configuration described in the first embodiment. The device deterioration estimation unit 107 and the maintenance management plan determination unit 108 are implemented by processing circuitry. The processing circuitry may be a combination of a memory for storing a program and a processor that executes the program stored in the memory, or may be a dedicated hardware element.

In the status analysis device 100b according to the present embodiment, as described above, the device deterioration estimation unit 107 predicts a deterioration time of, for example, a component used in the additive manufacturing system 200b, in the time section determined by the extraction time determination unit 105, on the basis of the synchronized log data. The maintenance management plan determination unit 108 determines a maintenance management plan including a time to perform maintenance of the additive manufacturing system 200b and a time to replace a component of the additive manufacturing system 200b on the basis of the deterioration time predicted by the device deterioration estimation unit 107. In addition to providing the advantage described in the first embodiment, this enables the status analysis device 100b to propose a maintenance management plan to, for example, the user of the status analysis device 100b. This can in turn improve maintainability of the additive manufacturing system 200b.

### Fourth Embodiment

A fourth embodiment will be described with respect to a case where a status analysis device determines a minimum sampling period when one of the measurement devices 101 measures a status of an additive manufacturing system.

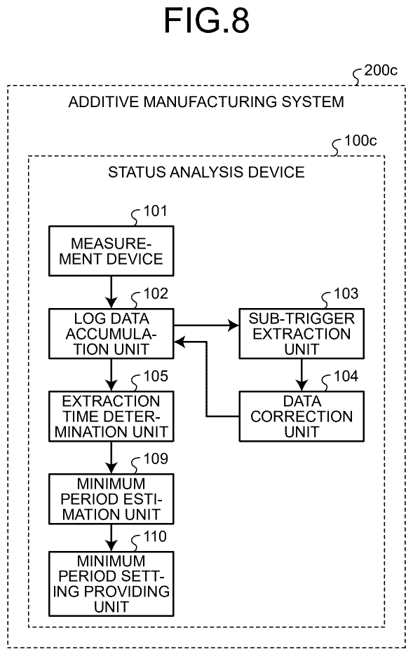

FIG. 8 is a diagram illustrating an exemplary configuration of a status analysis device 100c according to the fourth embodiment. The status analysis device 100c further includes a minimum period estimation unit 109 and a minimum period setting providing unit 110 in addition to the components of the status analysis device 100 illustrated in FIG. 1. Although the status analysis device 100c is illustrated in the example of FIG. 8 as being installed in an additive manufacturing system 200c, the status analysis device 100c may be installed outside the additive manufacturing system 200c; however, at least one of the multiple measurement devices 101 of the status analysis device 100c is installed in the additive manufacturing system 200c. The following description is made, by way of example, as to the status analysis device 100c installed in the additive manufacturing system 200c, that is, the additive manufacturing system 200c including the status analysis device 100c, as illustrated in FIG. 8.

The additive manufacturing system 200c is a system that produces an object on a workpiece by stacking multiple layers of beads while moving a fabrication point along a fabrication path, the beads being produced by addition of melted fabrication material to a fabrication surface of the workpiece. The status analysis device 100c is a device that monitors the additive manufacturing system 200c and analyzes the status of the workpiece, the status of the object, or the status of the additive manufacturing system 200c.

In the status analysis device 100c, the measurement devices 101, the log data accumulation unit 102, the sub-trigger extraction unit 103, the data correction unit 104, and the extraction time determination unit 105 operate similarly to those components used in the first embodiment.

The minimum period estimation unit 109 estimates a minimum sampling period on the basis of the synchronized log data and the multiple pieces of the log data not yet synchronized with one another, the minimum sampling period being a period in which a communication time to transfer the log data from the measurement devices 101 to the log data accumulation unit 102 is equal to or less than a predetermined threshold. For example, when a measurement device 101 is to be added to or removed from the status analysis device 100c, prediction of the minimum sampling period in the status analysis device 100c will be difficult without using actual performance data, i.e., data such as the synchronized log data and the multiple pieces of the log data. Using the synchronized log data and the multiple pieces of the log data, thus, the minimum period estimation unit 109 estimates a settable minimum sampling period from a difference in synchronization timing among the measurement devices 101. Note that the minimum period estimation unit 109 may operate not to estimate a minimum sampling period when the difference in synchronization timing among the measurement devices 101 is within an acceptable range, but to estimate a minimum sampling period when the difference in synchronization timing among the measurement devices 101 exceeds the acceptable range.

The minimum period setting providing unit 110 outputs candidates for use in sampling setting that are consistent with the minimum sampling period estimated by the minimum period estimation unit 109, for the multiple measurement devices 101. Regarding the candidates for use in sampling setting that are consistent with the minimum sampling period estimated, the minimum period setting providing unit 110 proposes, to the user of the status analysis device 100c, that, for example, acquisition items of the log data to be obtained by the measurement devices 101 be increased or decreased, the sampling periods of the individual measurement devices 101 be adjusted, a higher-performance log data storage device be procured, and/or a measurement device 101 having a larger buffer capacity be procured.

A hardware configuration of the status analysis device 100c according to the fourth embodiment will next be described. In the status analysis device 100c, components from the measurement device 101 to the extraction time determination unit 105 have the hardware configuration described in the first embodiment. The minimum period estimation unit 109 and the minimum period setting providing unit 110 are implemented by processing circuitry. The processing circuitry may be a combination of a memory for storing a program and a processor that executes the program stored in the memory, or may be a dedicated hardware element.

In the status analysis device 100c according to the present embodiment, as described above, the minimum period estimation unit 109 estimates a minimum sampling period on the basis of the synchronized log data and the multiple pieces of the log data not yet synchronized with one another. The minimum period setting providing unit 110 outputs candidates for use in sampling setting that are consistent with the minimum sampling period estimated. In addition to providing the advantage described in the first embodiment, this enables the status analysis device 100c to specifically output candidates for use in sampling setting that are consistent with the minimum sampling period. This can in turn improve maintainability of the additive manufacturing system 200c.

### Fifth Embodiment

A fifth embodiment will be described with respect to a case where a status analysis device visualizes log data in which a high degree of synchronism has been ensured to thus allow the user of the status analysis device to use the log data in a user-friendly manner.

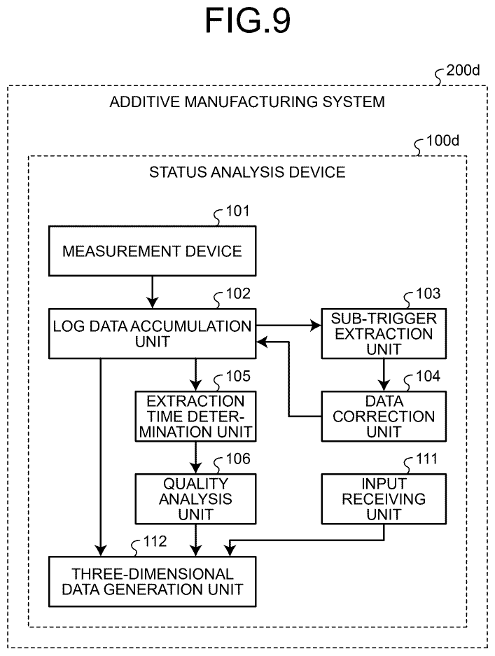

FIG. 9 is a diagram illustrating an exemplary configuration of a status analysis device 100d according to the fifth embodiment. The status analysis device 100d further includes an input receiving unit 111 and a three-dimensional data generation unit 112 in addition to the components of the status analysis device 100a illustrated in FIG. 5. Although the status analysis device 100d is illustrated in the example of FIG. 9 as being installed in an additive manufacturing system 200d, the status analysis device 100d may be installed outside the additive manufacturing system 200d; however, at least one of the multiple measurement devices 101 of the status analysis device 100d is installed in the additive manufacturing system 200d. The following description is made, by way of example, as to the status analysis device 100d installed in the additive manufacturing system 200d, that is, the additive manufacturing system 200d including the status analysis device 100d, as illustrated in FIG. 9.

The additive manufacturing system 200d is a system that produces an object on a workpiece by stacking multiple layers of beads while moving a fabrication point along a fabrication path, the beads being produced by addition of a melted fabrication material to a fabrication surface of the workpiece. The status analysis device 100d is a device that monitors the additive manufacturing system 200d and analyzes the status of the workpiece, the status of the object, or the status of the additive manufacturing system 200d.

In the status analysis device 100d, the measurement devices 101, the log data accumulation unit 102, the sub-trigger extraction unit 103, the data correction unit 104, the extraction time determination unit 105, and the quality analysis unit 106 operate similarly to those components used in the second embodiment.

The input receiving unit 111 receives, from an external entity, an input specifying a portion of an additively manufactured object made up of the workpiece and the object. The input receiving unit 111 outputs, to the three-dimensional data generation unit 112, information received from the external entity, the information being about the portion of the additively manufactured object made up of the workpiece and the object. The “external entity” that provides the input receiving unit 111 with the specified input is, for example, a user of the status analysis device 100d. Regarding how to provide the input receiving unit 111 with the specified input, the external entity may specify a particular layer of the multiple layers to be stacked, use a drawing when a drawing such as a design drawing of the object is usable, or use an image included in log data captured by a camera when the multiple measurement devices 101 include the camera.

The three-dimensional data generation unit 112 generates three-dimensional composite data on the basis of the synchronized log data and the multiple pieces of the log data not yet synchronized with one another, the three-dimensional composite data representing at least one of a building condition, a building parameter, an image, an analysis result, and an evaluation result, for the specified portion, together with a three-dimensional drawing of the additively manufactured object. The building condition is, for example, an axial feed quantity, an axial feed speed, a laser output, etc. obtainable from a G code which an NC device that is one type of the measurement devices 101 actually used during building. The building parameter is, for example, a setting value for the NC device other than a setting value of a G code, such as the time constant of an acceleration-deceleration filter. The image is what has been captured by a camera when the multiple measurement devices 101 include the camera. The analysis result is information obtained from the quality analysis unit 106. The evaluation result is, for example, information such as a positional relationship between the wire 210 and the molten pool 220, as illustrated in FIG. 6 described in the second embodiment when the multiple measurement devices 101 include a camera. The evaluation result may instead be, for example, a result of comparison between data obtained by measurement performed by that one of the measurement devices 101 and a preset threshold. The three-dimensional data generation unit 112 is capable of generating a three-dimensional drawing of the additively manufactured object by using, for example, computer aided design (CAD) data, computer aided manufacturing (CAM) data, etc. on the additively manufactured object. The three-dimensional data generation unit 112 may obtain CAD data on the additively manufactured object that is included in log data output from the NC device, such as a G code, or may obtain CAD data, CAM data, etc. which, for example, a user of the status analysis device 100d stores in advance in the log data accumulation unit 102, or a user of the status analysis device 100d inputs from the input receiving unit 111.

A hardware configuration of the status analysis device 100d according to the fifth embodiment will next be described. In the status analysis device 100d, components from the measurement device 101 to the quality analysis unit 106 have the hardware configuration described in the second embodiment. The input receiving unit 111 is an interface used in a personal computer, and is, for example, a keyboard, a mouse, and/or the like. The three-dimensional data generation unit 112 is implemented by processing circuitry. The processing circuitry may be a combination of a memory for storing a program and a processor that executes the program stored in the memory, or may be a dedicated hardware element.

In the status analysis device 100d according to the present embodiment, as described above, the input receiving unit 111 receives specification of a partial portion of the additively manufactured object from, for example, the user of the status analysis device 100d. The three-dimensional data generation unit 112 generates three-dimensional composite data on the basis of the synchronized log data and the multiple pieces of the log data not yet synchronized with one another, the three-dimensional composite data representing at least one of a building condition, a building parameter, an image, an analysis result, and an evaluation result, for the specified portion, together with a three-dimensional drawing of the additively manufactured object. In addition to providing the advantages described in the second embodiment, this enables the status analysis device 100d to generate three-dimensional composite data, using the synchronized log data having a high degree of synchronism, and output the three-dimensional composite data as a result of building, the three-dimensional composite data three-dimensionally illustrating a building condition etc. for a particular layer or portion specified by, for example, a user of the status analysis device 100d. In addition, the status analysis device 100d can improve maintainability of the additive manufacturing system 200d.

### Sixth Embodiment

A sixth embodiment will be described with respect to a case where a status analysis device provides, to the user of the status analysis device, a building condition recommended for a building-condition correction point of an additive manufacturing system, extracted by the quality analysis unit 106.

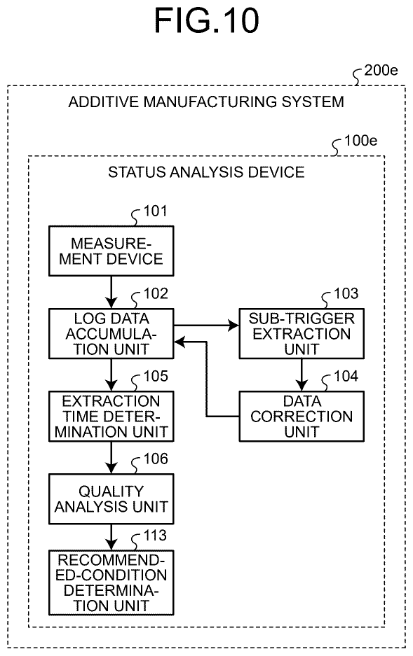

FIG. 10 is a diagram illustrating an exemplary configuration of a status analysis device 100e according to the sixth embodiment. The status analysis device 100e further includes a recommended-condition determination unit 113 in addition to the components of the status analysis device 100a illustrated in FIG. 5. Although the status analysis device 100e is illustrated in the example of FIG. 10 as being installed in an additive manufacturing system 200e, the status analysis device 100e may be installed outside the additive manufacturing system 200e; however, at least one of the multiple measurement devices 101 of the status analysis device 100e is installed in the additive manufacturing system 200e. The following description is made, by way of example, as to the status analysis device 100e installed in the additive manufacturing system 200e, that is, the additive manufacturing system 200e including the status analysis device 100e, as illustrated in FIG. 10.

The additive manufacturing system 200e is a system that produces an object on a workpiece by stacking multiple layers of beads while moving a fabrication point along a fabrication path, the beads being produced by addition of a melted fabrication material to a fabrication surface of the workpiece. The status analysis device 100e is a device that monitors the additive manufacturing system 200e and analyzes the status of the workpiece, the status of the object, or the status of the additive manufacturing system 200e.

In the status analysis device 100e, the measurement devices 101, the log data accumulation unit 102, the sub-trigger extraction unit 103, the data correction unit 104, the extraction time determination unit 105, and the quality analysis unit 106 operate similarly to those components used in the second embodiment.

The recommended-condition determination unit 113 outputs a building condition recommended, i.e., a recommended condition, for a building-condition correction point extracted by the quality analysis unit 106. When there are multiple recommended conditions, the recommended-condition determination unit 113 may display the recommended conditions in a list format according to a criterion such as the order of operability of changing. Specific description will be given below with reference to, by way of example, FIG. 6(b) described in the second embodiment. As described above, FIG. 6(b) illustrates a situation in which the wire 210 is melted in a left-side portion of the molten pool 220, i.e., in a portion on the side that supplies the wire 210, the molten pool 220 has a large height, and vibration is induced on the wire 210. In this case, the quality analysis unit 106 determines that, in the additive manufacturing system 200a, the wire 210 vibrates with a small amplitude as the wire 210 forced into the molten pool 220 is melted in such a manner that the wire parts the molten pool 220; thus, the quality analysis unit 106 extracts such status as a building-condition correction point. In response to the building-condition correction point extracted by the quality analysis unit 106, the recommended-condition determination unit 113 outputs multiple recommended conditions in a list format so as to allow the wire 210 to melt smoothly, the recommended conditions being, for example, to increase the output of the laser used for melting the wire 210, reduce the feed rate of the wire 210, and increase the feed angle of the wire 210.

In this respect, the recommended conditions output by the recommended-condition determination unit 113 in response to a building-condition correction point extracted by the quality analysis unit 106 depend on, for example, the material used in the additive manufacturing system 200e and the shape of the additively manufactured object made up of the workpiece and the object. Thus, the manufacturer of the status analysis device 100e, the user of the status analysis device 100e, etc. may pre-register candidate recommended conditions in the recommended-condition determination unit 113, for building-condition correction points that may potentially be extracted by the quality analysis unit 106 according to the types, the installation locations, the number, and the like of the measurement devices 101. In addition, pre-registration of candidate recommended conditions would be difficult such as when a new material will be used in the additive manufacturing system 200e. Accordingly, the recommended-condition determination unit 113 may observe the quality of melting as a state quantity, from log data, and learn recommended conditions, using a technology such as artificial intelligence (AI).

A hardware configuration of the status analysis device 100e according to the sixth embodiment will next be described. In the status analysis device 100e, components from the measurement device 101 to the quality analysis unit 106 have the hardware configuration described in the second embodiment. The recommended-condition determination unit 113 is implemented by processing circuitry. The processing circuitry may be a combination of a memory for storing a program and a processor that executes the program stored in the memory, or may be a dedicated hardware element.

In the status analysis device 100e according to the present embodiment, as described above, the recommended-condition determination unit 113 outputs a recommended condition for a building-condition correction point extracted by the quality analysis unit 106. In addition to providing the advantages described in the second embodiment, this enables the status analysis device 100e to output, to, for example, the user of the status analysis device 100e, a candidate recommended condition to improve a building condition needing the correction. This can in turn improve maintainability of the additive manufacturing system 200e.

### Seventh Embodiment

A seventh embodiment will be described with respect to a case where a user of a status analysis device or the like performs remote monitoring via the status analysis device.

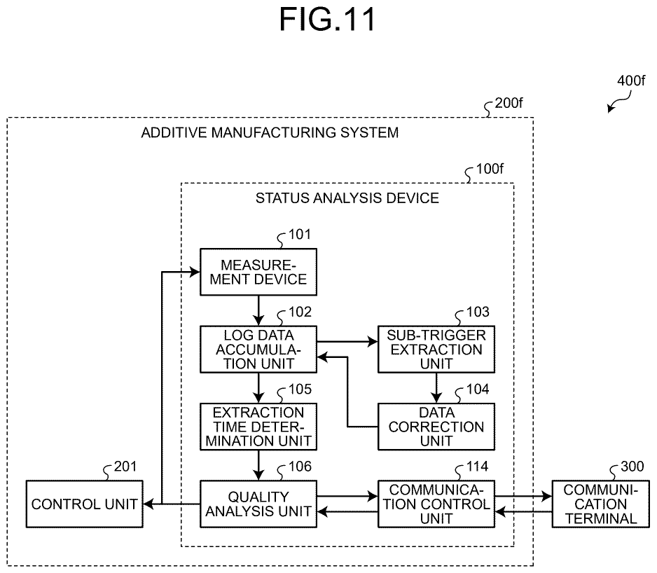

FIG. 11 is a diagram illustrating an exemplary configuration of a status analysis device 100f according to the seventh embodiment. The status analysis device 100f further includes a communication control unit 114 in addition to the components of the status analysis device 100a illustrated in FIG. 5. Although the status analysis device 100f is illustrated in the example of FIG. 11 as being installed in an additive manufacturing system 200f, the status analysis device 100f may be installed outside the additive manufacturing system 200f; however, at least one of the multiple measurement devices 101 of the status analysis device 100f is installed in the additive manufacturing system 200f. The following description is made, by way of example, as to the status analysis device 100f installed in the additive manufacturing system 200f, that is, the additive manufacturing system 200f including the status analysis device 100f, as illustrated in FIG. 11.

The additive manufacturing system 200f is a system that produces an object on a workpiece by stacking multiple layers of beads while moving a fabrication point along a fabrication path, the beads being produced by addition of melted fabrication material to a fabrication surface of the workpiece. The additive manufacturing system 200f includes a control unit 201 for controlling operation of the entire additive manufacturing system 200f. The status analysis device 100f is a device that monitors the additive manufacturing system 200f and analyzes the status of the workpiece, the status of the object, or the status of the additive manufacturing system 200f.

In the seventh embodiment, the status analysis device 100f is connected with a communication terminal 300, which is provided outside the additive manufacturing system 200f. The communication terminal 300 is a communication device usable by a user of the status analysis device 100f or the like. In the seventh embodiment, the additive manufacturing system 200f including the status analysis device 100f and the communication terminal 300 together form a remote monitoring system 400f.

In the status analysis device 100f, the measurement devices 101, the log data accumulation unit 102, the sub-trigger extraction unit 103, the data correction unit 104, and the extraction time determination unit 105 operate similarly to those components used in the second embodiment.

When receiving, from the communication terminal 300 provided outside the additive manufacturing system 200f, a request for sending synchronized log data and time-series information on building-condition correction points, the communication control unit 114 obtains the synchronized log data and the time-series information on building-condition correction points from the quality analysis unit 106, and sends the synchronized log data and the time-series information to the communication terminal 300. When receiving, from the communication terminal 300, a corrected building condition for a building-condition correction point, the communication control unit 114 outputs the corrected building condition to the quality analysis unit 106.

In addition to operating similarly to the quality analysis unit 106 in the second embodiment, the quality analysis unit 106 outputs the synchronized log data and the time-series information on building-condition correction points to the communication control unit 114 in response to the request of the communication control unit 114, and outputs, to the control unit 201 of the manufacturing system 200f, the corrected building condition obtained from the communication control unit 114.

The communication terminal 300 is operated by, for example, the user of the status analysis device 100f, and sends, to the status analysis device 100f, a request for sending synchronized log data and time-series information on building-condition correction points. In addition, when receiving the synchronized log data and the time-series information on building-condition correction points from the status analysis device 100f as the response to the sending request, the communication terminal 300 displays the synchronized log data and the time-series information on the received building-condition correction points, to, for example, the user of the status analysis device 100f. Moreover, when receiving, from, for example, the user of the status analysis device 100f, a corrected building condition for a building-condition correction point, the communication terminal 300 sends, to the status analysis device 100f, the corrected building condition for the received building-condition correction point. Note that before sending the corrected building condition for the received building-condition correction point, the communication terminal 300 may take a preliminary step of indicating, to the quality analysis unit 106, a point needing monitoring with greater attention.

The control unit 201 of the manufacturing system 200f receives the corrected building condition for a building-condition correction point, sent from the communication terminal 300 via the communication control unit 114 and the quality analysis unit 106. The control unit 201 corrects the building condition on the basis of the corrected building-condition for the received building-condition correction point, and operates to form an object on the workpiece accordingly.

A hardware configuration of the status analysis device 100f according to the seventh embodiment will next be described. In the status analysis device 100f, components from the measurement device 101 to the quality analysis unit 106 have the hardware configuration described in the second embodiment. The communication control unit 114 is implemented by processing circuitry. The processing circuitry may be a combination of a memory for storing a program and a processor that executes the program stored in the memory, or may be a dedicated hardware element. Note that, in the remote monitoring system 400f, the control unit 201 of the manufacturing system 200f is implemented by processing circuitry. The processing circuitry may be a combination of a memory for storing a program and a processor that executes the program stored in the memory, or may be a dedicated hardware element. In addition, the communication terminal 300 is implemented by a communication device.

In the status analysis device 100f according to the present embodiment, as described above, the communication control unit 114 obtains synchronized log data and time-series information on building-condition correction points from the quality analysis unit 106, and sends the synchronized log data and the time-series information to the communication terminal 300. When receiving, from the communication terminal 300, a corrected building condition for a building-condition correction point, the communication control unit 114 outputs the corrected building condition to the quality analysis unit 106. The quality analysis unit 106 outputs the corrected building condition obtained from the communication control unit 114, to the control unit 201 of the manufacturing system 200f. This enables the status analysis device 100f to provide advantages similar to the advantages described in the second embodiment. In addition, the additive manufacturing system 200f is capable of operating to form an object on the workpiece, using the building condition which the user, etc. of the status analysis device 100f corrects via the communication terminal 300. That is, the user, etc. of the status analysis device 100f can remotely specify the operation of the additive manufacturing system 200f via the communication terminal 300.

Note that the seventh embodiment has been described in which the status analysis device 100f further includes the communication control unit 114 in addition to the components of the status analysis device 100a of the second embodiment, but the configuration is not limited thereto. For example, a status analysis device may further include the communication control unit 114 in addition to the components of the status analysis device 100b of the third embodiment, and send the maintenance management plan determined by the maintenance management plan determination unit 108, from the communication control unit 114 to the communication terminal 300. In addition, a status analysis device may further include the communication control unit 114 in addition to the components of the status analysis device 100c of the fourth embodiment, and send, from the communication control unit 114 to the communication terminal 300, the minimum sampling period estimated by the minimum period estimation unit 109, the candidates for use in sampling setting output from the minimum period setting providing unit 110, etc. Moreover, a status analysis device may further include the communication control unit 114 in addition to the components of the status analysis device 100d of the fifth embodiment, and send, from the communication control unit 114 to the communication terminal 300, the three-dimensional composite data generated by the three-dimensional data generation unit 112 and/or the like. Furthermore, a status analysis device may further include the communication control unit 114 in addition to the components of the status analysis device 100e of the sixth embodiment, and send, from the communication control unit 114 to the communication terminal 300, the recommended condition obtained by the recommended-condition determination unit 113. In the case where a status analysis device further includes the communication control unit 114 in addition to the components of the status analysis device 100e of the sixth embodiment, the status analysis device may output the recommended condition obtained by the recommended-condition determination unit 113 to the control unit 201 such that whether to reflect the recommended condition in an operation of the additive manufacturing system is determined by the user, etc. of the status analysis device 100f through the communication control unit 114. Alternatively, the status analysis device may ensure that using the communication control unit 114, the user, etc. of the status analysis device 100f select, from multiple recommended conditions, a recommended condition to be actually used.

### Eighth Embodiment

An eighth embodiment will be described with respect to a case where a status analysis device uses a result of simulation.

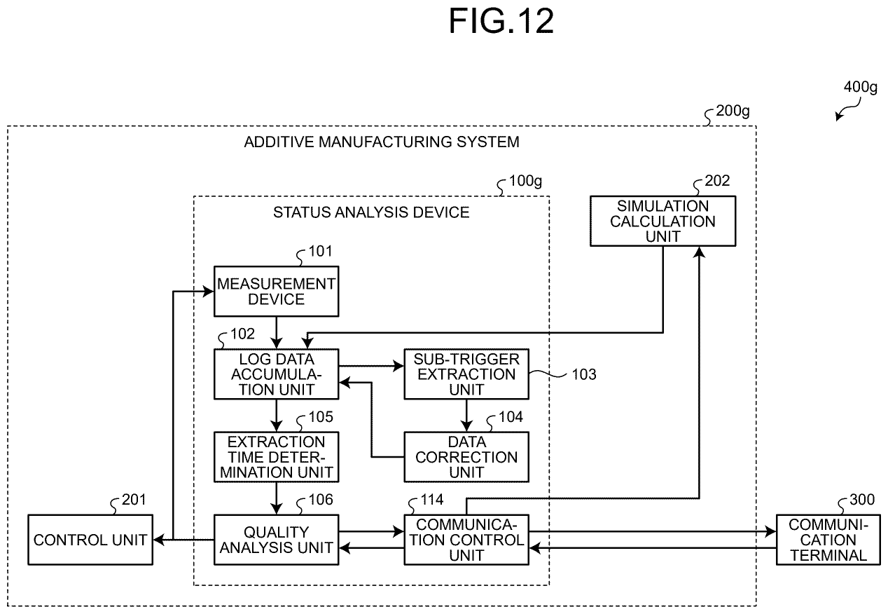

FIG. 12 is a diagram illustrating an exemplary configuration of a status analysis device 100g according to the eighth embodiment. The status analysis device 100g is configured in such a manner that a simulation calculation unit 202 is connected to the status analysis device 100f illustrated in FIG. 11. Although the status analysis device 100g is illustrated in the example of FIG. 12 as being installed in an additive manufacturing system 200g, the status analysis device 100g may be installed outside the additive manufacturing system 200g; however, at least one of the multiple measurement devices 101 of the status analysis device 100g is installed in the additive manufacturing system 200g. The following description is made, by way of example, as to the status analysis device 100g installed in the additive manufacturing system 200g, that is, the additive manufacturing system 200g including the status analysis device 100g, as illustrated in FIG. 12. The simulation calculation unit 202 may also be installed inside the additive manufacturing system 200g as illustrated in FIG. 12, or outside the additive manufacturing system 200g.

The additive manufacturing system 200g is a system that produces an object on a workpiece by stacking multiple layers of beads while moving a fabrication point along a fabrication path, the beads being produced by addition of melted fabrication material to a fabrication surface of the workpiece. The additive manufacturing system 200g includes the control unit 201 for controlling operation of the entire additive manufacturing system 200g. The control unit 201 operates similarly to the control unit 201 in the seventh embodiment. The status analysis device 100g is a device that monitors the additive manufacturing system 200g and analyzes the status of the workpiece, the status of the object, or the status of the additive manufacturing system 200g.

In the eighth embodiment, the status analysis device 100g is connected with the communication terminal 300, which is provided outside the additive manufacturing system 200g. The communication terminal 300 is a communication device usable by a user of the status analysis device 100g or the like. The communication terminal 300 operates similarly to the communication terminal 300 in the seventh embodiment. In the eighth embodiment, the additive manufacturing system 200g including the status analysis device 100g and the communication terminal 300 together form a remote monitoring system 400g.

In the status analysis device 100g, the measurement devices 101, the sub-trigger extraction unit 103, the data correction unit 104, the extraction time determination unit 105, and the quality analysis unit 106 operate similarly to those components used in the seventh embodiment.

In addition to operating as described in the seventh embodiment, the communication control unit 114 is capable of outputting, to the simulation calculation unit 202, the synchronized log data and the time-series information on building-condition correction points obtained from the quality analysis unit 106, and sending, to the simulation calculation unit 202, the corrected building condition obtained from the communication terminal 300. Note that, among the synchronized log data and the time-series information on building-condition correction points obtained from the quality analysis unit 106, and among the corrected building condition obtained from the communication control unit 114, the communication control unit 114 may output, to the simulation calculation unit 202, only the synchronized log data and time-series information indicated by the communication terminal 300 and/or only part thereof.

The simulation calculation unit 202 is capable of performing simulation of operation of the additive manufacturing system 200g. For example, the simulation calculation unit 202 is capable of simulating an operation of an NC device that is one type of the measurement devices 101, and performing simulation of operation of the additive manufacturing system 200g, using the corrected building condition obtained from the communication terminal 300 via the communication control unit 114. The operation is however not limited thereto. Following a determination made by a user of the additive manufacturing system 200g, the simulation calculation unit 202 may perform only simulation of core part of the operation of additive manufacturing performed by the additive manufacturing system 200g. An example of the simulation of core part of the operation of additive manufacturing is, but not limited to, thermal deformation simulation of the workpiece or the object during additive manufacturing. When long time or actual time simulation needs to be performed in the additive manufacturing system 200g, the simulation calculation unit 202 is capable of performing remotely-operated simulation in accordance with an instruction from the communication terminal 300. Long time simulation is, for example, simulation in a case of building of a large object, etc. Actual time simulation is, for example, simulation aiming also at processing load measurement for the NC device, a sensor, and/or the like. Actual time simulation is performed in cases such as when operation of a newly installed sensor needs to be checked without operating the additive manufacturing system 200g. The simulation calculation unit 202 outputs a result of a performed simulation to the log data accumulation unit 102.

The log data accumulation unit 102 accumulates the log data obtained from the measurement devices 101 and the synchronized log data obtained from the data correction unit 104 similarly to the case described in the seventh and previous embodiments, and further accumulates, as log data, the result of simulation performed by the simulation calculation unit 202 capable of performing simulation of operation of the additive manufacturing system 200g.

A hardware configuration of the status analysis device 100g according to the eighth embodiment will next be described. In the status analysis device 100g, components from the measurement device 101 to the quality analysis unit 106 and the communication control unit 114 have the hardware configuration described in the seventh embodiment. Note that, in the remote monitoring system 400g, the control unit 201 of the manufacturing system 200g has the hardware configuration described in the seventh embodiment. The simulation calculation unit 202 of the additive manufacturing system 200g is implemented by processing circuitry. The processing circuitry may be a combination of a memory for storing a program and a processor that executes the program stored in the memory, or may be a dedicated hardware element. In addition, the communication terminal 300 has the hardware configuration described in the seventh embodiment.

In response to the result of simulation performed by the simulation calculation unit 202 on the basis of, for example, information obtained from the communication control unit 114, the status analysis device 100g according to the present embodiment is capable of performing, as described above, operations such as extraction of sub-triggers by the sub-trigger extraction unit 103, generation of the synchronized log data by the data correction unit 104, determination of the time section by the extraction time determination unit 105, and extraction of building-condition correction points in temporal order by the quality analysis unit 106.

### Ninth Embodiment

The eighth embodiment has been described in which the simulation calculation unit 202 performs simulation according to an instruction or information obtained from the communication control unit 114. A ninth embodiment will be described with respect to a case where the simulation calculation unit 202 performs simulation, using information that has been specified in advance, and a status analysis device operates using a simulation result from the simulation calculation unit 202.

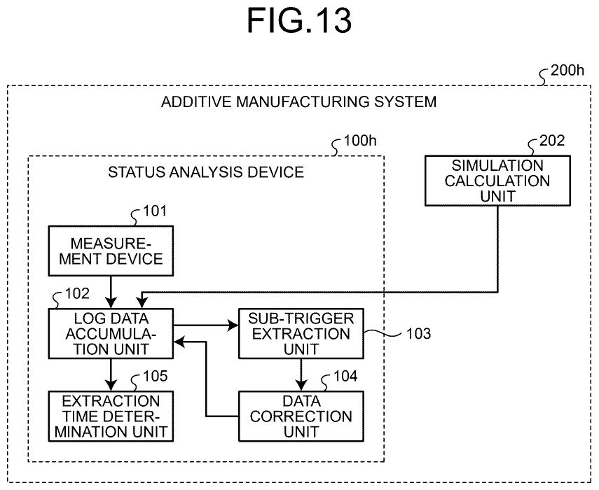

FIG. 13 is a diagram illustrating an exemplary configuration of a status analysis device 100h according to the ninth embodiment. The status analysis device 100h is configured similarly to the status analysis device 100 illustrated in FIG. 1, but is connected with the simulation calculation unit 202. Although the status analysis device 100h is illustrated in the example of FIG. 13 as being installed in an additive manufacturing system 200h, the status analysis device 100h may be installed outside the additive manufacturing system 200h; however, at least one of the multiple measurement devices 101 included in the status analysis device 100h is installed in the additive manufacturing system 200h. The following description is made, by way of example, as to the status analysis device 100h installed in the additive manufacturing system 200h, that is, the additive manufacturing system 200h including the status analysis device 100h, as illustrated in FIG. 13. The simulation calculation unit 202 may also be installed inside the additive manufacturing system 200h as illustrated in FIG. 13, or outside the additive manufacturing system 200h.

The additive manufacturing system 200h is a system that produces an object on a workpiece by stacking multiple layers of beads while moving a fabrication point along a fabrication path, the beads being produced by addition of melted fabrication material to a fabrication surface of the workpiece. The status analysis device 100h is a device that monitors the additive manufacturing system 200h and analyzes the status of the workpiece, the status of the object, or the status of the additive manufacturing system 200h.

In the status analysis device 100h, components from the measurement device 101 to the extraction time determination unit 105 operate similarly to those components used in the eighth embodiment.

The simulation calculation unit 202 is capable of performing simulation of operation of the additive manufacturing system 200h. In the eighth embodiment, the simulation calculation unit 202 performs simulation basically according to an instruction or information obtained from the communication control unit 114. In fact, the simulation calculation unit 202 is capable of performing simulation by using information specified in advance, without obtaining information or an instruction from the communication control unit 114. The simulation calculation unit 202 that uses information specifiable in advance is capable of performing simulation similar to the simulation described in the eighth embodiment.

The hardware configuration of the status analysis device 100h and the like according to the ninth embodiment is the same as the hardware configuration described in the eighth and previous embodiments, and detailed description thereof will therefore be omitted.

In response to the result of simulation performed by the simulation calculation unit 202 on the basis of, for example, information specified in advance, the status analysis device 100h according to the present embodiment is capable of performing, as described above, operations such as extraction of sub-triggers by the sub-trigger extraction unit 103, generation of the synchronized log data by the data correction unit 104, and determination of the time section by the extraction time determination unit 105.

The configurations described in the foregoing embodiments are merely examples. These configurations may be combined with another known technology, and configurations of different embodiments may be combined together. Moreover, part of such configurations may be omitted and/or modified without departing from the spirit.

### REFERENCE SIGNS LIST

100, 100a, 100b, 100c, 100d, 100e, 100f, 100g, 100h status analysis device; 101 measurement device; 102 log data accumulation unit; 103 sub-trigger extraction unit; 104 data correction unit; 105 extraction time determination unit; 106 quality analysis unit; 107 device deterioration estimation unit; 108 maintenance management plan determination unit; 109 minimum period estimation unit; 110 minimum period setting providing unit; 111 input receiving unit; 112 three-dimensional data generation unit; 113 recommended-condition determination unit; 114 communication control unit; 200, 200a, 200b, 200c, 200d, 200e, 200f, 200g, 200h additive manufacturing system; 201 control unit; 202 simulation calculation unit; 210 wire; 220 molten pool; 300 communication terminal; 400f, 400g remote monitoring system; 900, 903 processing circuitry; 901 processor; 902 memory.

1. A status analysis device to monitor an additive manufacturing system to produce an object on a workpiece by stacking a plurality of layers of beads while moving a fabrication point along a fabrication path, the beads being produced by addition of a melted fabrication material to a fabrication surface of the workpiece, the status analysis device comprising:
a plurality of measurement circuits each to measure a status of the workpiece, a status of the object, or a status of the additive manufacturing system, and output a time-series measurement result as log data including logging items;
log data accumulation circuitry to accumulate a plurality of pieces of the log data obtained from the plurality of measurement devices;
sub-trigger extraction circuitry to extract sub-triggers from the plurality of pieces of the log data, the sub-triggers each being an event included in the log data, the event associating a measurement time of a corresponding one of the plurality of pieces of the log data with a reference time, the reference time being a time basis common to the plurality of pieces of the log data;
data correction circuitry to correct a time deviation among the plurality of pieces of the log data on a basis of the sub-triggers to generate synchronized log data, the synchronized log data having the plurality of pieces of the log data synchronized with one another; and
extraction time determination circuitry to obtain the synchronized log data, and determine, on a basis of the reference time, a time section for use in analysis.

2. The status analysis device according to claim 1, wherein
the plurality of pieces of the log data includes, at least: an image captured by a camera, the camera being one type of the measurement devices; or a wire load and data capable of identifying at least one of a change in a temperature of a tip portion of a wire or a change in a temperature near a molten pool of the wire melted, the wire being used as the fabrication material, the wire load being force exerted from the object on the wire, the wire load being measured by a sensor, the sensor being one type of the measurement devices, and
the status analysis device further comprises
quality analysis circuitry to extract, in temporal order, correction points of a building condition for the additive manufacturing system, on a basis of the synchronized log data.

3. The status analysis device according to claim 1, comprising:
device deterioration estimation circuitry to predict a deterioration time on a basis of the synchronized log data, the deterioration time being a time of occurrence of deterioration at which accuracy in additive manufacturing performed by the additive manufacturing system exceeds a predetermined range of tolerance; and
maintenance management plan determination circuitry to determine, on a basis of the deterioration time, a maintenance management plan including a time to perform maintenance of the additive manufacturing system and a time to replace a component of the additive manufacturing system.

4. The status analysis device according to claim 1, comprising:
minimum period estimation circuitry to estimate a minimum sampling period on a basis of the synchronized log data and the plurality of pieces of the log data not yet synchronized with one another, the minimum sampling period being a period in which a communication time to transfer the log data from the measurement devices to the log data accumulation circuitry is equal to or less than a predetermined threshold; and
minimum period setting providing circuitry to output candidates for use in sampling setting that are consistent with the minimum sampling period, for the plurality of measurement devices.

5. The status analysis device according to claim 2, comprising:
an input receiver to receive, from an external entity, an input specifying a portion of an additively manufactured object, the additively manufactured object being made up of the workpiece and the object; and
three-dimensional data generation circuitry to generate three-dimensional composite data on a basis of the synchronized log data and the plurality of pieces of the log data not yet synchronized with one another, the three-dimensional composite data representing at least one of a building condition, a building parameter, an image, an analysis result, or an evaluation result, for the specified portion, together with a three-dimensional drawing of the additively manufactured object.

6. The status analysis device according to claim 2, comprising:
recommended-condition determination circuitry to output a building condition recommended for one of the correction points of the building condition.

7. The status analysis device according to claim 2, comprising:
communication control circuitry to:
obtain the synchronized log data and time-series information on the correction points of the building condition from the quality analysis circuitry and send the synchronized log data and the time-series information on the correction points of the building condition to a communication terminal provided outside the additive manufacturing system when the communication control circuitry receives, from the communication terminal, a request for sending the synchronized log data and the time-series information on the correction points of the building condition; and
output a corrected building condition for one of the correction points of the building condition to the quality analysis circuitry when the communication control circuitry receives the corrected building condition from the communication terminal, wherein
the quality analysis circuitry outputs, to the additive manufacturing system, the corrected building condition obtained from the communication control circuitry.

8. The status analysis device according to claim 7, wherein
the log data accumulation circuitry further accumulates, as log data, a result of simulation of operation of the additive manufacturing system, the simulation being performed by simulation calculation circuitry, the simulation calculation circuitry being capable of performing the simulation, and
the communication control circuitry sends the corrected building condition to the simulation calculation circuitry.

9. The status analysis device according to claim 1, wherein
the plurality of measurement circuits comprise a camera that outputs images of a molten pool on the fabrication surface in temporal order.

10. An additive manufacturing system comprising the status analysis device according to claim 1, wherein at least one of the plurality of measurement circuits of the status analysis device is installed in the additive manufacturing system.

11. A status analysis method for use in a status analysis device to monitor an additive manufacturing system to produce an object on a workpiece by stacking a plurality of layers of beads while moving a fabrication point along a fabrication path, the beads being produced by addition of a melted fabrication material to a fabrication surface of the workpiece, the status analysis method comprising:
measuring a status of the workpiece, a status of the object, or a status of the additive manufacturing system, and outputting a time-series measurement result as log data including logging items;
accumulating a plurality of pieces of the log data obtained;
extracting sub-triggers from the plurality of pieces of the log data, the sub-triggers each being an event included in the log data, the event associating a measurement time of a corresponding one of the plurality of pieces of the log data with a reference time, the reference time being a time basis common to the plurality of pieces of the log data;
correcting a time deviation among the plurality of pieces of the log data on a basis of the sub-triggers to generate synchronized log data, the synchronized log data having the plurality of pieces of the log data synchronized with one another;
accumulating the synchronized log data; and
obtaining the synchronized log data, and determining on a basis of the reference time, a time section for use in analysis.
